(19) United States
(12) Patent Application Publication
(10) Pub. No.: US 2015/0352718 A1
(43) Pub. Date: Dec. 10, 2015

(54) CONTROLLER FOR MULTIPLE ROBOT USING WIRELESS TEACHING PENDANT AND METHOD FOR CONTROLLING THEREOF

(71) Applicant: AJINEXTEK CO., LTD., Dalseo-gu, Daegu (KR)

(72) Inventors: Tae Min Lee, Busan (KR); Chang Ho Kim, Daegu (KR); Sung Hyuk Choi, Daegu (KR); Sang Tae Lee, Daegu (KR)

(21) Appl. No.: 14/760,505

(22) PCT Filed: Apr. 25, 2013
(86) PCT No.: PCT/KR2013/003562

§ 371 Date: Jul. 13, 2015

(30) Foreign Application Priority Data
Feb. 12, 2013 (KR) 10-2013-0014956

(51) Int. Cl. B25J 9/16; B25J 13/00; B25J 9/00

(52) U.S. Cl. CPC B25J 9/1669; B25J 9/0084; B25J 13/006; Y10S 901/03; Y10S 901/08

(57) ABSTRACT

A multiple robot control apparatus using a teaching pendant and a control method thereof. The method of controlling a plurality of robots by a teaching pendant based on an access point (AP) includes the steps of: transmitting first information to the AP by the teaching pendant; transmitting the first information to a plurality of related master boards by the AP; outputting a drive pulse signal using the first information by each of the plurality of master boards; and operating the plurality of robots respectively connected to the plurality of master boards according to the drive pulse signal, in which the teaching pendant operates on an Android platform, and the teaching pendant, the AP and the plurality of motion master boards communicate using at least either a short range communication or a wireless communication.

### FIELD OF THE INVENTION

The present invention relates to a multiple robot control apparatus using a wireless teaching pendant and a control method thereof. Specifically, the present invention provides an apparatus for simultaneously controlling a plurality of robots through wireless communication using an access point by a teaching pendant, and a control method thereof.

### BACKGROUND OF THE INVENTION

A teaching pendant is a device used for industrial equipments or robots, which is configured to be small using only key buttons and an LCD for the convenience of a user usually in an industrial field where a monitor and a mouse cannot be used or in an automated equipment which does not need to be specially handled, and the teaching pendant is used in connection with one equipment through a cable.

Specifically, the teaching pendant is used to make a program for teaching an initial position value and driving a simple sequence using a Jog mode in the field and advantageously used to monitor a state of an equipment in real-time or to change parameters of the equipment.

Currently, the teaching pendant is controlled using a cable, and it is configured to connect one teaching pendant to one equipment.

However, length of the cable of a present teaching pendant is limited depending on performance of the pendant.

The modes for operating the teaching pendant can be largely classified into two modes, and, first, a jog mode is a mode for arbitrarily adjusting a moving direction and a speed of the device using buttons, which is mainly used for teaching an initial position value.

In addition, a user mode is used to manipulate software (S/W) provided by a company using a TFT-LCD and buttons and program and drive a sequence desired by a user, and this is used to monitor a state of an equipment in real-time using an LCD.

However, the teaching pendant products currently commercialized in the market are connected through a cable, and a plurality of teaching pendants is required to manage the whole production line configured of a plurality of equipments. Accordingly, there are disadvantages such as increase of cost according to the number of teaching pendants, limitation in the range of movement of a user due to the cables, inconvenience of attaching and detaching the pendants, and the like.

Furthermore, since the teaching pendant products are also disadvantageous in that additional cost is required according to the functions of buttons and the structure of the teaching pendant when hardware (H/W, e.g., buttons or the like of the pendant) is upgraded or changed according to software (S/W), a solution for solving the problem is required.

### SUMMARY OF THE INVENTION

### Technical Problem

Therefore, the present invention has been made in view of the above problems, and it is an object of the present invention to provide a user with a multiple robot control apparatus using a wireless teaching pendant and a control method thereof.

Specifically, an object of the present invention is to provide a user with a multiple robot control apparatus for transmitting and receiving data using wireless communication and a control method thereof, in which a teaching PAD (T-PAD) configured with an interface using an Android platform is used as a teaching pendant, and an access point is placed between the T-PAD and a motion controller for driving an equipment.

Meanwhile, technical problems to be solved by the present invention are not limited to the technical problems described above, and other unmentioned technical problems will be clearly understood by those skilled in the art from the following descriptions.

### Solution to the Problem

To accomplish the above object, according to one aspect of the present invention, there is provided a method of controlling a plurality of robots by a teaching pendant based on an access point (AP), the method including the steps of: transmitting first information to the AP by the teaching pendant; transmitting the first information to a plurality of related master boards by the AP; outputting a drive pulse signal using the first information by each of the plurality of master boards; and operating the plurality of robots respectively connected to the plurality of master boards according to the drive pulse signal, in which the teaching pendant operates on an Android platform, and the teaching pendant, the AP and the plurality of motion master boards may communicate using at least either a short range communication or a wireless communication.

In addition, the short range communication may use at least one of techniques including Wireless-Fidelity (WiFi), Bluetooth, Radio Frequency Identification (RFID), infrared Data Association (IrDA), Ultra Wideband (UWB) and ZigBee, and the wireless communication may use at least one of techniques including code division multiple access (CDMA), frequency division multiple access (FDMA), time division multiple access (TDMA), orthogonal frequency division multiple access (OFDMA), and single carrier frequency division multiple access (SC-FDMA).

In addition, the method of controlling a plurality of robots further includes the steps of: transmitting a request message to the AP by the teaching pendant; transmitting the request message to the plurality of related master boards by the AP; transmitting a response message to the AP as a response to the request message by a first master board which is at least one of the plurality of master boards; and transmitting the response message to the teaching pendant by the AP, in which the first information may be transmitted only to the first master board.

In addition, the AP may be provided in plurality, and each of the plurality of APs may transmit the first information only to a plurality of master boards related to the AP itself.

In addition, at least some of the plurality of master boards may support an EtherCAT protocol.

In addition, the plurality of master boards may transmit and receive data to and from each other using the AP.

According to another aspect of the present invention, there is provided a multiple robot control system including: a teaching pendant for transmitting first information to an AP; the AP for transmitting the first information to a plurality of master boards related to the AP; the plurality of master boards for outputting a drive pulse signal using the first information; and a plurality of robots respectively connected to the plurality of master boards and operating according to the drive pulse signal, in which the teaching pendant operates on an Android platform, and the teaching pendant, the AP and the plurality of motion master boards may communicate using at least either a short range communication or a wireless communication.

In addition, the short range communication may use at least one of techniques including Wireless-Fidelity (WiFi), Bluetooth, Radio Frequency Identification (RFID), infrared Data Association (IrDA), Ultra Wideband (UWB) and ZigBee, and the wireless communication may use at least one of techniques including code division multiple access (CDMA), frequency division multiple access (FDMA), time division multiple access (TDMA), orthogonal frequency division multiple access (OFDMA), and single carrier frequency division multiple access (SC-FDMA).

### Advantageous Effects of the Invention

The present invention may provide a user with a multiple robot control apparatus using a wireless teaching pendant and a control method thereof.

Specifically, the present invention may provide a user with a multiple robot control apparatus for transmitting and receiving data using wireless communication and a control method thereof, in which a teaching PAD (T-PAD) configured with an interface using an Android platform is used as a teaching pendant, and an access point is placed between the T-PAD and a motion controller for driving an equipment.

Meanwhile, the effects obtained from the present invention are not limited to the effects described above, and other unmentioned effects will be clearly understood by those skilled in the art from the following descriptions.

### BRIEF DESCRIPTION OF THE DRAWINGS

The above and other objects, features and advantages of the present invention will be apparent from the following detailed description of the preferred embodiments of the present invention in conjunction with the accompanying drawings, in which:

FIG. 1 is a view illustrating a specific example of a conventional system for controlling multiple robots using a teaching pendant in relation to the present invention;

FIG. 2 is a block diagram showing an example of a teaching pendant applicable to the present invention;

FIG. 3a is a view showing an example of a teaching pendant applicable to the present invention, and FIG. 3b is a view illustrating a detailed specification of the teaching pendant applicable to the present invention;

FIG. 4 is a view illustrating a specific example of a system for controlling multiple robots to which a teaching pendant according to the present invention is applied;

FIG. 5 is a view showing an example of the concept of wireless communication between a teaching pendant and a motion master board in relation to the present invention;

FIG. 6 is a view showing an example of a communication procedure between a teaching pendant and a motion master board in relation to the present invention;

FIG. 7 is a view showing a specific example of a line expansion management configuration using an access point in relation to the present invention; and

FIG. 8 is a view showing a specific example of a motion control configuration using an EtherCAT in relation to the present invention.

### DETAILED DESCRIPTION

A teaching pendant is a device used for industrial equipments or robots, which is configured to be small using only key buttons and an LCD for the convenience of a user usually at an industrial field where a monitor and a mouse cannot be used or in an automated equipment which does not need to be specially handled, and the teaching pendant is used in connection with one equipment through a wire.

Specifically, the teaching pendant is used to make a program for teaching an initial position value and driving a simple sequence using a Jog mode in the field and advantageously used to monitor a state of an equipment in real-time or to change parameters of the equipment.

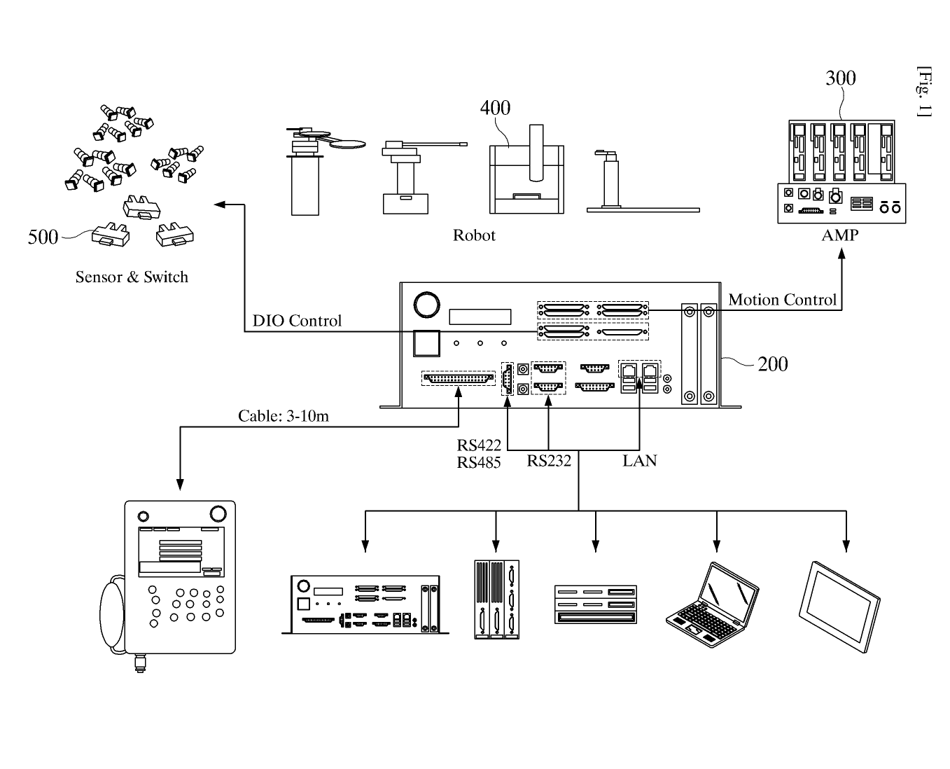

FIG. 1 is a view illustrating a specific example of a conventional system for controlling multiple robots using a teaching pendant in relation to the present invention.

The system disclosed in FIG. 1 is a system for controlling multiple robots using a teaching pendant which is currently available in the market.

Referring to FIG. 1, the system for controlling multiple robots may includes a teaching pendant 100, a control board 200, an amplifier 300, robots 400 and sensors and switches 500, and the control board 200 may include an ARC-II 610, an Ethernet/IP 620, a PLC 630, a PC 640 and a touch panel 650. Since the constitutional components shown in FIG. 1 are not necessarily required, a multiple robot control system having further more or further less constitutional components may be implemented.

Referring to FIG. 1, if a command desired by a user is transmitted using the teaching pendant 100 connected through a cable, a motion master board mounted inside the ARC-II 610 outputs the corresponding command in the form of a pulse and drives the robot 400.

In addition, a current equipment state can be confirmed in real-time through the control board 200.

The modes for operating the teaching pendant disclosed in FIG. 1 can be largely classified into two modes, and, first, a jog mode is a mode for arbitrarily adjusting a moving direction and a speed of a device using buttons, which is mainly used for teaching an initial position value.

In addition, a user mode is used to manipulate software (S/W) provided by a company using a TFT-LCD and buttons and program and drive a sequence desired by a user, and this is used to monitor a state of an equipment in real-time using an LCD.

However, the teaching pendant disclosed in FIG. 1 is controlled using a cable, and it is configured to connect one teaching pendant to one equipment, and length of the cable of a present teaching pendant is limited depending on performance of the pendant.

In addition, the teaching pendant products of FIG. 1 are connected through a cable, and a plurality of teaching pendants is required to manage the whole production line configured of a plurality of equipments. Accordingly, there are disadvantages such as increase of cost according to the number of teaching pendants, limitation in the range of movement of a user due to the cables, inconvenience of attaching and detaching the pendants, and the like.

In addition, the teaching pendant products of FIG. 1 are also disadvantageous in that additional cost is required according to the functions of buttons and the structure of the teaching pendant when hardware (H/W, e.g., buttons or the like of the pendant) is upgraded or changed according to software (S/W).

Accordingly, the present invention provides an apparatus for simultaneously controlling a plurality of robots through wireless communication using an access point by a teaching pendant, and a control method thereof.

Before describing operation of the present invention in detail, a preferred embodiment of a wireless teaching pendant applied to the present invention will be described hereinafter.

The embodiment described below dose not unduly limit the contents of the present invention specified in the claims, and the entire configuration described in the embodiment may not be absolutely necessary as a means for solving the problems of the present invention.

Hereinafter, a wireless teaching pendant of the present invention will be described in detail.

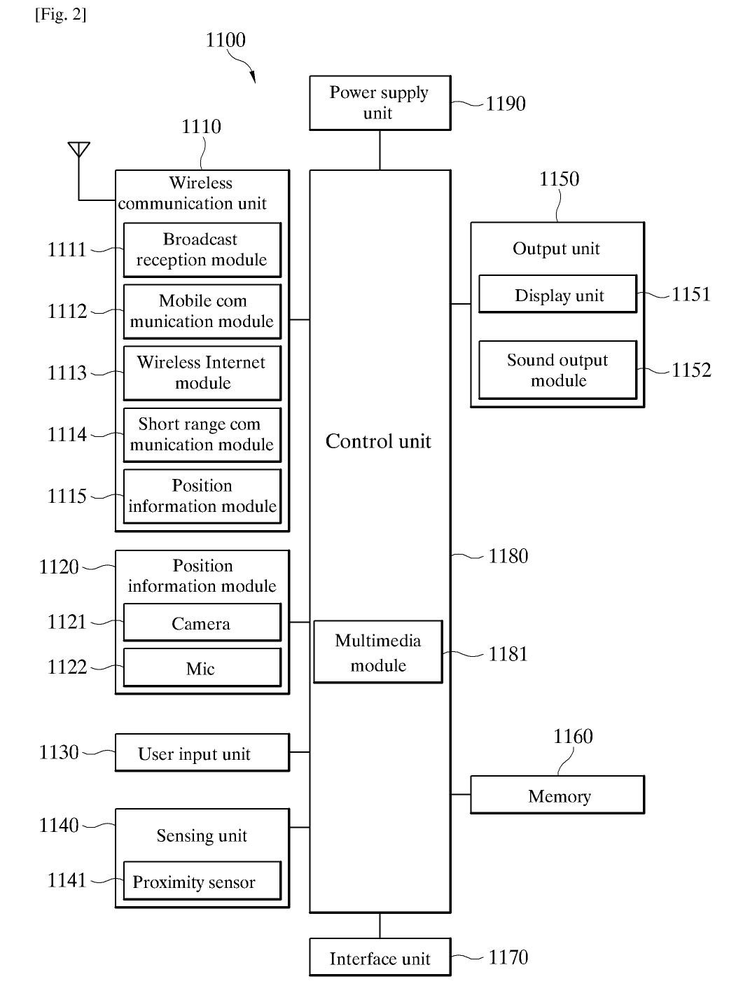

FIG. 2 is a block diagram showing an example of a teaching pendant applicable to the present invention.

The wireless teaching pendant 1100 may include a wireless communication unit 1110, an audio/video (A/V) input unit 1120, a user input unit 1130, a sensing unit 1140, an output unit 1150, memory 1160, an interface unit 1170, a control unit 1180 and a battery 1190. Since the constitutional components shown in FIG. 2 are not necessarily required, a wireless teaching pendant 1100 having further more or further less constitutional components may be implemented.

Hereinafter, the constitutional components will be described in order.

The wireless communication unit 1110 may include one or more modules which enable wireless communication between the wireless teaching pendant 1100 and a wireless communication system or between the wireless teaching pendant 1100 and a network in which the wireless teaching pendant 1100 is positioned. For example, the wireless communication unit 1110 may include a broadcast reception module 1111, a mobile communication module 1112, a wireless Internet module 1113, a short range communication module 1114 and a position information module 1115.

The broadcast reception module 1111 receives broadcasting signals and/or broadcasting related information from an external broadcasting management server through a broadcasting channel.

The broadcasting channel may include a satellite channel and a terrestrial wave channel. The broadcasting management server may mean a server which creates and transmits broadcasting signals and/or broadcasting related information or a sever which receives previously created broadcasting signals and/or broadcasting related information and transmits the received broadcasting signals and/or broadcasting related information to the wireless teaching pendant 1100. The broadcasting signals include not only TV broadcasting signals, radio broadcasting signals and data broadcasting signals, but also broadcasting signals combining the data broadcasting signals with the TV broadcasting signals or the radio broadcasting signals.

The broadcasting related information may means information related to a broadcasting channel, a broadcasting channel, a broadcasting program or a broadcasting service provider. The broadcasting related information may be provided through a mobile communication network. In this case, the broadcasting related information may be received by the mobile communication module 1112.

The broadcasting related information may exist in a variety of forms. For example, the broadcasting related information may exist in the form of Electronic Program Guide (EPG) of Digital Multimedia Broadcasting (DMB), Electronic Service Guide (ESG) of Digital Video Broadcast-Handheld (DVB-H) or the like.

The broadcast reception module 1111 may receive digital broadcasting signals using a digital broadcasting system such as Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), DVB-CBMS, OMA-BCAST, Integrated Services Digital Broadcast-Terrestrial (ISDB-T) or the like. Of course, the broadcast reception module 1111 may be configured to be suitable for broadcasting systems in addition to the digital broadcasting system described above.

The broadcasting signals and/or the broadcasting related information received through the broadcast reception module 1111 may be stored in the memory 1160.

The mobile communication module 1112 transmits and receives wireless signals to and from at least one of a base station, an external terminal and a server on the mobile communication network. The wireless signals may include a voice call signal, a video communication call signal or various types of data according to transmission and reception of character/multimedia messages.

The wireless Internet module 1113 is a module for wireless Internet connection, which can be installed inside or outside of the wireless teaching pendant 1100.

Wireless LAN (WLAN) (Wi-Fi), Wireless broadband (Wibro), World Interoperability for Microwave Access (Wimax), High Speed Downlink Packet Access (HSDPA) or the like can be used as a technique of the wireless Internet.

The short range communication module 1114 is a module for short range communication. Bluetooth, Radio Frequency Identification (RFID), infrared Data Association (IrDA), Ultra Wideband (UWB), ZigBee or the like can be used as a technique of the short range communication.

The position information module 1115 is a module for acquiring a position of the wireless teaching pendant 1100, and a representative example thereof is a Global Positioning System (GPS) module. According to the current technique, the GPS module 1115 may accurately calculate 3-dimensional information on the current position according to latitude, longitude and height by calculating information on the distance from at least three or more satellites and accurate time information and then applying the calculated information to trigonometry. Currently, a method of calculating position and time information using three satellites and correcting an error in the calculated position and time information using another satellite is widely used. In addition, the GPS module 1115 may calculate information on the speed by continuously calculating the current position in real-time.

Referring to FIG. 2, the audio/video (A/V) input unit 1120 is for inputting an audio signal or a video signal, which may include a camera 1121 and a mic 1122. The camera 1121 processes an image frame such as a still image or a moving image obtained from an image sensor in a video communication mode or a photographing mode. The processed image frame may be displayed on a display unit 1151.

The image frame processed by the camera 1121 may be stored in the memory 1160 or transmitted to outside through the wireless communication unit 1110.

At this point, two or more cameras 1121 may be provided depending on a use environment.

For example, first and second cameras 1121a and 1121b for photographing 3D images may be provided as the camera 1121 on a side opposite to a side where the display unit 1151 of the wireless teaching pendant 1100 is provided, and a third camera 1121c for self-photographing by a user may be provided in some area on the side where the display unit 1151 of the wireless teaching pendant 1100 is provided.

At this point, the first camera 1121a is for photographing a left eye image, which is a source image of a 3D image, and the second camera 1121b is for photographing a right eye image.

The mic 1122 receives an external audio signal through a microphone in a communication mode, a recording mode or a voice recognition mode and processes the audio signal into electrical voice data. In the case of the communication mode, the processed voice data may be converted into a form transmittable to a base station and output through the mobile communication module 1112. A variety of noise reduction algorithms for removing noises generated in the process of receiving the external audio signal may be implemented in the mic 1122.

The user input unit 1130 generates input data for controlling operation of the wireless teaching pendant 1100 by the user.

The user input unit 1130 may receive a signal specifying two or more contents among the contents displayed according to the present invention from the user. Then, the signal specifying two or more contents may be received through a touch input or a hard key and soft key input.

The user input unit 1130 may receive an input for selecting one content or two or more contents from the user. In addition, the user input unit 1130 may receive an input for creating an icon related to a function that can be performed by the wireless teaching pendant 1100 from the user.

The user input unit 1130 described above may be configured of direction keys, a keypad, a dome switch, a (resistive/capacitive) touchpad, a jog wheel, a jog switch and the like.

The sensing unit 1140 senses a current state of the wireless teaching pendant 1100 such as an open and close state of the wireless teaching pendant 1100, a position of the wireless teaching pendant 1100, whether or not a user has contacted, an azimuth of the wireless teaching pendant 1100, acceleration/deceleration of the wireless teaching pendant 1100 or the like and generates a sensing signal for controlling operation of the wireless teaching pendant 1100. For example, when the wireless teaching pendant 1100 is a type of a slide phone, the sensing unit 1140 may sense whether the slide phone is open or closed. In addition, the sensing unit 1140 may also sense whether or not power is supplied from the battery 1190, whether or not the interface unit 1170 is combined with an external device, or the like. Meanwhile, the sensing unit 1140 may include a proximity sensor 1141. The proximity sensor 1141 will be described below in relation to a touch screen.

The output unit 1150 is for generating an output related to a visual sense, an aural sense, a tactile sense or the like, and the output unit 1150 may include a display unit 1151, a sound output module 1152, an alarm unit 1153, a haptic module 1154 and a projector module 1155.

The display unit 1151 displays (outputs) information processed by the wireless teaching pendant 1100. For example, when the wireless teaching pendant 1100 is in the communication mode, the display unit 1151 displays a user interface (UI) or a graphic user interface (GUI) related to communication. When the wireless teaching pendant 1100 is in the video communication mode or the photographing mode, the display unit 1151 displays a photographed and/or received image, or the UI or the GUI.

In addition, the display unit 1151 supports 2D and 3D display modes.

That is, the display unit 1151 according to the present invention may have a configuration combining a switch liquid crystal 1151b with a general display device 1151a. Then, the display unit 1151 may operate an optical parallax barrier 50 using the switch liquid crystal 1151b to separate light by controlling traveling direction of the light so that different lights may arrive at the left and right eyes respectively. Therefore, when an image combining an image for the left eye and an image for the right eye is displayed on the display device 1151a, a corresponding image is shown in each of the eyes from the viewpoint of a user, and thus the user feels as if a 3D image is displayed.

That is, in the 2D display mode, the display unit 1151 performs a general 2D display operation by driving only the display device 1151a, not driving the switch liquid crystal 1151b and the optical parallax barrier 50, under the control of the control unit 1180.

In addition, in the 3D display mode, the display unit 1151 performs a 3D display operation by driving the switch liquid crystal 1151b, the optical parallax barrier 50 and the display device 1151a under the control of the control unit 1180.

Meanwhile, the display unit 1151 described above may include at least one of a liquid crystal display (LCD), a thin film transistor-liquid crystal display (TFT LCD), an organic light-emitting diode (OLED), a flexible display and a 3D display.

Some of these displays may be configured as a transparent type or a light transmissive type so as to see outside through the displays. This may be called as a transparent display, and a representative example of the transparent display is a Transparent OLED (TOLED) or the like. The backend structure of the display unit 1151 may also be configured as a light transmissive type. Owing to such structures, a user may see an object positioned at the rear of the wireless teaching pendant 1100 body through an area occupied by the display unit 1151 of the wireless teaching pendant 1100 body.

Two or more display units 1151 may exist depending on an implementation type of the wireless teaching pendant 1100. For example, in the wireless teaching pendant 1100, a plurality of display units may be arranged to be spaced from one another or in one piece on one surface or may be arranged on different surfaces.

When the display unit 1151 and a sensor for sensing a touch operation (hereinafter, referred to as a ‘touch sensor’) form a layered structure with each other, the display unit 1151 may be used as an input device as well as an output device. The touch sensor may be formed in, for example, a touch film, a touch sheet, a touchpad or the like.

The touch sensor may be configured to convert a change in the pressure applied to a specific portion of the display unit 1151 or the electrostatic capacitance generated at a specific portion of the display unit 1151 into an electrical input signal. The touch sensor may be configured to detect even the pressure of a touch, as well as a touched position and area.

When the touch sensor senses a touch input, a signal (signals) corresponding to the touch input is sent to a touch controller (not shown). The touch controller processes the signal (signals) and transmits a corresponding data to the control unit 1180. Therefore, the control unit 1180 may figure out a touched area or the like of the display unit 1151.

The proximity sensor 1141 may be arranged in an internal area of the wireless teaching pendant 1100 surrounded by the touch screen or in the neighborhood of the touch screen. The proximity sensor is a sensor for detecting an object approaching a certain detection surface or existing in the neighborhood of the detection surface using an electromagnetic force or infrared rays without a mechanical contact. The proximity sensor has a long lifespan and a high utility compared with a contact type sensor.

Examples of the proximity sensor include a transmissive photoelectric sensor, a diffuse reflective photoelectric sensor, a retro-reflective photoelectric sensor, a high frequency oscillation proximity sensor, a capacitive proximity sensor, a magnetic proximity sensor, an infrared proximity sensor and the like. In the case of a capacitive touch screen, the touch screen is configured to detect approach of a pointer based on changes in the electrical field corresponding to the approach of the pointer. In this case, the touch screen (touch sensor) may be classified as a proximity sensor.

Hereinafter, for the convenience of explanation, a behavior of recognizing approaching and positioning of a pointer on the touch screen while the pointer does not contact with the touch screen is referred to as a “proximity touch”, and a behavior of a pointer actually contacting with the touch screen is referred to as a “contact touch”. A position of a proximity touch of the pointer on the touch screen means a position on the touch screen vertically corresponding to the pointer when the pointer is proximity-touched.

The proximity sensor senses a proximity touch and a proximity touch pattern (e.g., a proximity touch distance, a proximity touch direction, a proximity touch speed, a proximity touch time, a proximity touch position, a proximity touch moving state and the like). Information corresponding to the sensed proximity touch operation and proximity touch pattern may be output on the touch screen.

The sound output module 1152 may output audio data received from the wireless communication unit 1110 or stored in the memory 1160 in a call signal reception mode, a communication mode, a recording mode, a voice recognition mode, a broadcast reception mode or the like. The sound output module 1152 may also output a sound signal related to a function (e.g., a call signal reception sound, a message reception sound or the like) performed by the wireless teaching pendant 1100. The sound output module 1152 may include a receiver, a speaker, a buzzer or the like.

The memory 1160 may store a program for processing and controlling the control unit 1180 or may perform a function of temporarily storing input/output data (e.g., a phone book, a message, an audio, a still image, an electronic book, a moving image, a transmission and reception message history, and the like). The memory 1160 may also store a frequency of using each of the data (e.g., a frequency of using a phone number, a message, a multimedia data or the like). In addition, the memory 1160 may store data related to vibrations and sounds of a variety of patterns output when a touch is input on the touch screen.

The memory 1160 may include at least a type of storage media including a flash memory, a hard disk, a multimedia micro card, a card type memory (e.g., an SD or XD memory), a RAM (Random Access Memory), a Static Random Access Memory (SRAM), a ROM (Read-Only Memory), an Electrically Erasable Programmable Read-Only Memory (EEPROM), a Programmable Read-Only Memory (PROM), a magnetic memory, a magnetic disk, and an optical disk. The wireless teaching pendant 1100 may operate in relation to a web storage which performs the storage function of the memory 1160 on the Internet.

The interface unit 1170 functions as a passage to all external devices connected to the wireless teaching pendant 1100. The interface unit 1170 receives data from an external device, receives and transfers power to each constitutional component inside the wireless teaching pendant 1100, or transmits internal data of the wireless teaching pendant 1100 to an external device. For example, the interface unit 1170 may include a wired/wireless headset port, an external charger port, a wired/wireless data port, a memory card port, a port for connecting a device provided with an identification module, an audio input/output (I/O) port, a video I/O port, an earphone port and the like.

The identification module is a chip for storing various kinds of information for authorizing a right to use the wireless teaching pendant 1100 and may include a User Identify Module (UIM), Subscriber Identify Module (SIM), a Universal Subscriber Identity Module (USIM) and the like. The device provided with an identification module (hereinafter, referred to as an ‘identification device’) can be manufactured in the form of a smart card. Accordingly, the identification device may be connected to the wireless teaching pendant 1100 through a port.

When the wireless teaching pendant 1100 is connected to a cradle, the interface unit may function as a passage for supplying power received from the cradle to the wireless teaching pendant 1100 or a passage for transferring various kinds of command signals input from the cradle by a user to the wireless teaching pendant 1100. The various kinds of command signals or the power received from the cradle may operate as a signal for recognizing that the wireless teaching pendant 1100 is correctly mounted on the cradle.

The control unit 1180 generally controls overall operation of the wireless teaching pendant 1100. For example, the control unit 1180 performs a control or a process related to voice communication, data communication, video communication or the like. The control unit 1180 may be provided with a multimedia module 1181 for multimedia playback. The multimedia module 1181 may be implemented in the control unit 1180 or may be implemented to be separate from the control unit 1180.

The control unit 1180 may perform a pattern recognition process for recognizing a handwriting input or a drawing input performed on the touch screen as a character or an image.

Meanwhile, when the display unit 1151 is provided as an organic light-emitting diode (OLED) or a Transparent OLED (TOLED), according to the present invention, if a size of a preview image input through the camera 1121 is adjusted by handling of a user while the preview image is pull-up displayed on the screen of the organic light-emitting diode (OLED) or the Transparent OLED (TOLED), the control unit 1180 may reduce consumption of power supplied to the display unit 1151 from the power supply unit 1190 by turning off drive of pixels in a second region of the screen, excluding a first region where the preview image whose size has been adjusted is displayed.

The power supply unit 1190 receives external power or internal power under the control of the control unit 1180 and supplies power needed for the operation of each constitutional component.

A variety of embodiments described here may be implemented in a recording medium that can be read through a computer or a device similar to the computer using software, hardware or a combination thereof.

According to hardware implementation, the embodiments described here may be implemented using at least one of an ASIC (application specific integrated circuit), a DSP (digital signal processor), a DSPD (digital signal processing device), a PLD (programmable logic device), an FPGA (field programmable gate array, a processor, a controller, a microcontroller, a microprocessor and other electrical units for performing other functions. In some cases, the embodiments described in the specification may be implemented as the control unit 1180 itself.

According to software implementation, embodiments of the procedures and functions described in this specification may be implemented as separate software modules. Each of the software modules may perform one or more functions or operations described in this specification. A software code may be implemented as a software application written in an appropriate program language. The software code may be stored in the memory 1160 and executed by the control unit 1180.

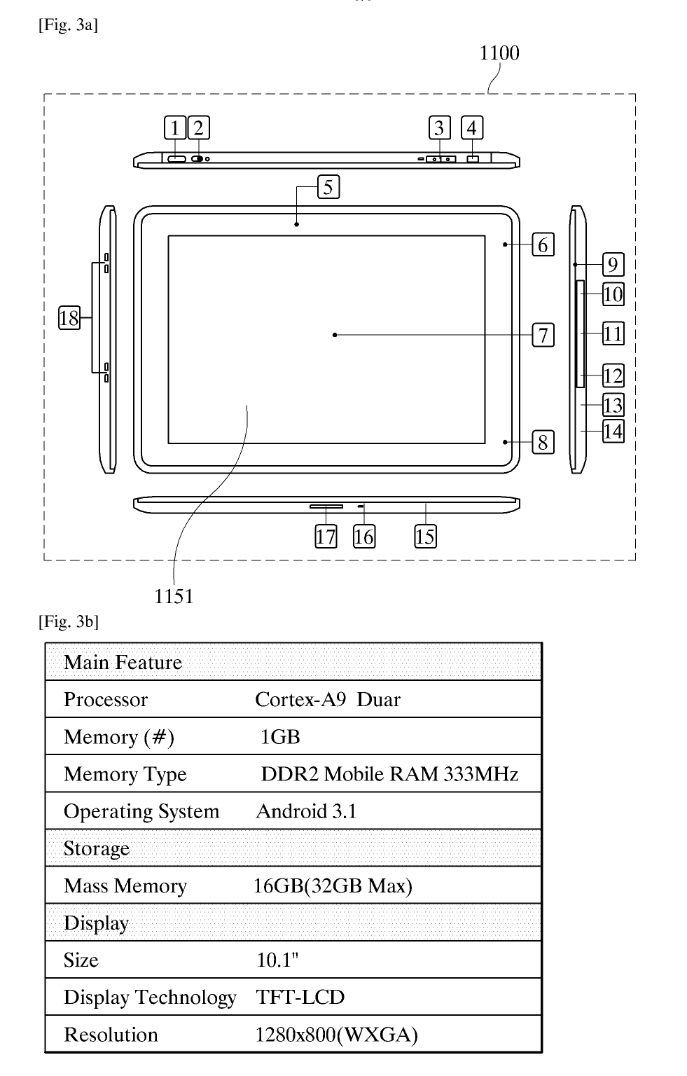

FIG. 3a is a view showing an example of a wireless teaching pendant 1100 applicable to the present invention, and FIG. 3b is a view illustrating a detailed specification of the wireless teaching pendant 1100 applicable to the present invention.

As is disclosed in FIG. 3a, the wireless teaching pendant 1100 applied to the present invention may be a Teaching PAD (T-PAD) in which an interface is configured using an Android platform.

The Android platform applied to the present invention is a software stack and operating system including an operating system, middleware, a user interface and standard application programs for a portable device such as a cellular phone.

In addition, the Android platform applied to the present invention provides various tools and application program interfaces (APIs) needed for developing application programs through a software development toolkit.

Referring to FIG. 3a, the wireless teaching pendant 1100 applied to the present invention may provide a plurality of functions.

First, the wireless teaching pendant 1100 includes a power button 1 and may provide a function of screen lock 2.

Next, the wireless teaching pendant 1100 may be provided with a volume control function 3 and a shutter button 4.

In addition, the wireless teaching pendant 1100 may include a front camera lens 5, a light sensor 6, a touch screen 7 and a recharge indicator 8 through the display unit 1151.

In addition, the wireless teaching pendant 1100 may include a mini USB port 9, an external micro SD card port 10, a USB port 11, a USIM card slot 12, an earphone connection jack 13 and a power connection jack on a side surface.

In addition, the wireless teaching pendant 1100 may include a microphone port 15, a reset button 16, a docking station connection jack 17 and a speaker 18.

On the other hand, FIG. 3b is a view illustrating a detailed specification of the wireless teaching pendant applicable to the present invention.

Referring to FIG. 3b, a processor applied to the control unit 1180 of the wireless teaching pendant 1100 is Cortex-A9 Dual, and the operating system may be Android 3.1 as described above.

In addition, the memory 1160 of the wireless teaching pendant 1100 may be 1 GB of DDR2 Mobile RAM 333 MHz, and mass memory may be 16 GB (32 GB in maximum).

In addition, the display unit 1151 of the wireless teaching pendant 1100 may be a TFT-LCD of 10.1″ having a resolution of 1280×800 (WXGA).

However, the detailed specification of the wireless teaching pendant applied to the present invention described above with reference to FIG. 3b is merely an example, and it is apparent that the wireless teaching pendant can be implemented in further diverse forms.

A multiple robot control system proposed in the present invention based on the wireless teaching pendant 1100 described above may use a wireless communication method between an equipment and the wireless teaching pendant 1100 and transmit and receive data through an access point or a tower lamp.

Such a method may drastically reduce the number of teaching pendants respectively needed for each equipment, and a user may be provided with convenience of connecting the teaching pendant to the equipment within a range capable of communication and handling or monitoring the equipment.

A wireless system applied in the present invention is a communication, monitoring or control system which carries signals through air using electromagnetic or sound waves. Most of wireless systems use RF representing a radio frequency or IR representing an infrared ray.

A short range communication method or a wireless communication method may be used as the communication method, and the short range communication may use at least one of techniques including Wireless-Fidelity (WiFi), Bluetooth, Radio Frequency Identification (RFID), infrared Data Association (IrDA), Ultra Wideband (UWB) and ZigBee.

In addition, the wireless communication may use at least one of techniques including code division multiple access (CDMA), frequency division multiple access (FDMA), time division multiple access (TDMA), orthogonal frequency division multiple access (OFDMA) and single carrier frequency division multiple access (SC-FDMA).

An access point or a tower lamp may be used to exchange data between the wireless teaching pendant 1100 and an equipment according to such a short range communication method or wireless communication method.

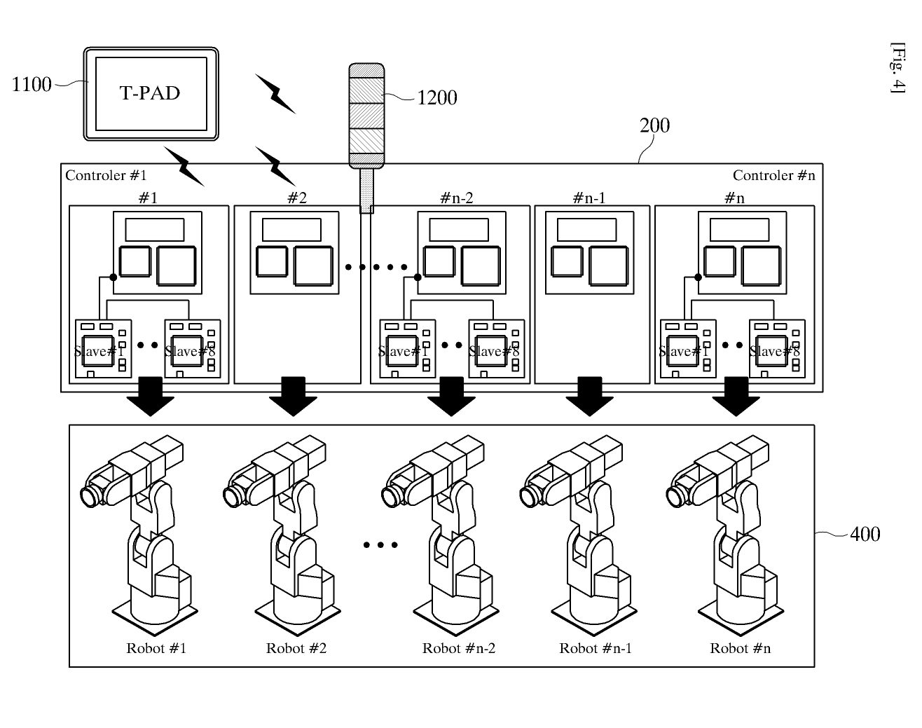

FIG. 4 is a view illustrating a specific example of a system for controlling multiple robots to which a teaching pendant according to the present invention is applied.

Referring to FIG. 4, the multiple robot control system proposed by the present invention may be configured of a wireless teaching pendant 1100, an access point 1200, a plurality of control units 200 and a plurality of robots 400.

Here, the plurality of control units 200 may mean the control board 200 described above or a motion master board of the ARC-II 610 included in the control board 200. Hereinafter, although it is assumed that the plurality of control units 200 applied in FIG. 4 is the motion master board of the ARC-II 610 for the convenience of explanation, the present invention is not limited thereto.

A Teaching PAD (T-PAD) configured with an interface using an Android platform is used as the wireless teaching pendant 1100 of FIG. 4 from which a user may issue a command.

An access point (AP) 1200 is placed between the Teaching PAD (T-PAD) and the motion controller 200 which drives an equipment, and data are transmitted and received between the Teaching PAD (T-PAD) and the motion controller 200 using a short range communication or a wireless communication.

Here, since the access point (AP) 1200 allows transmission and reception of data between equipments, in addition to wireless communication between the Teaching PAD (T-PAD) and an equipment, it may improve working speed.

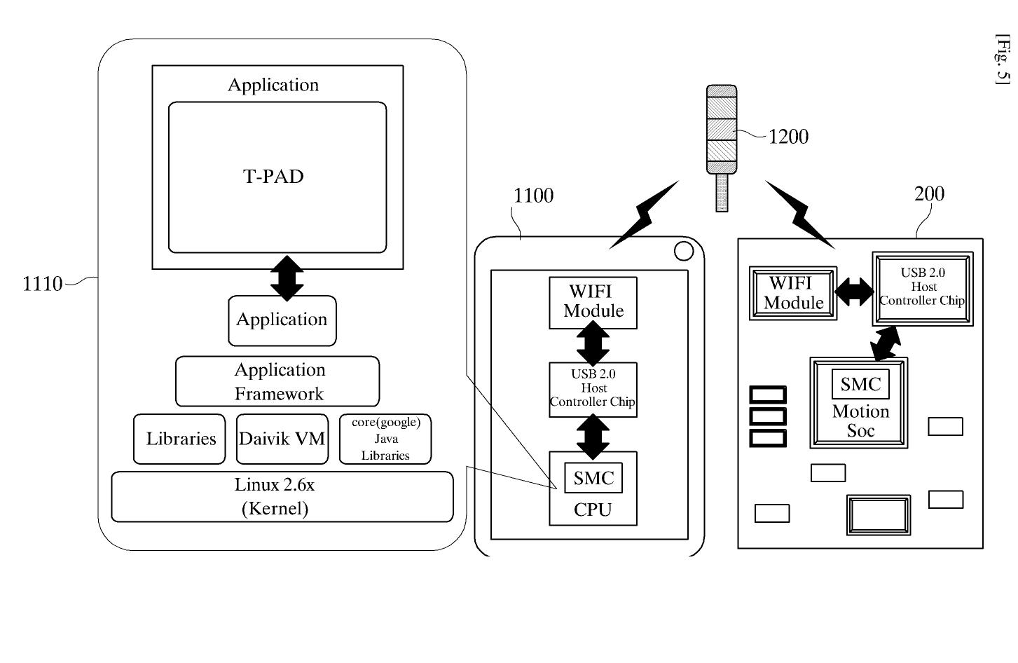

FIG. 5 is a view showing an example of the concept of wireless communication between a teaching pendant and a motion master board in relation to the present invention.

The multiple robot control system using a wireless T-PAD based on Android is configured using a motion master board of the T-PAD shown in FIG. 5, and the detail communication sequence and the configuration of the Android are as described below.

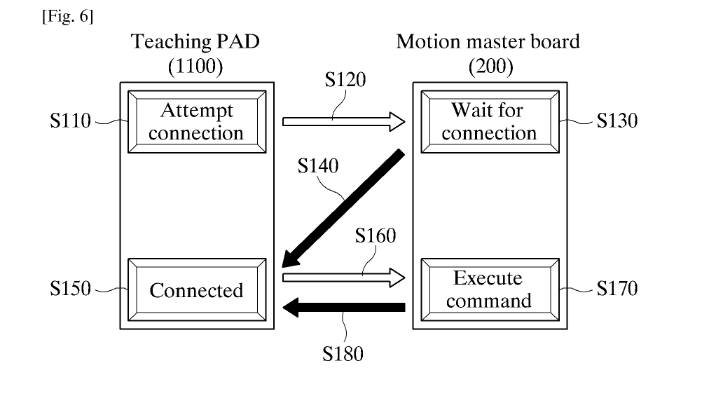

FIG. 5 is a conceptual view showing the concept of wireless communication between a teaching PAD 1100 and a motion master board 200, and FIG. 6 is a view showing an example of a communication procedure between a teaching pendant and a motion master board in relation to the present invention.

A user transmits a desired motion command to a robot using an application (motion control S/W) created based on Android.

This command is transferred from the CPU to the access point (tower lamp) 1200 through a USB 2.0 Host Controller and a WiFi module.

The command transferred to the access point 1200 is transferred to the WiFi module when a connection approval command is input into the motion master board 200 and transferred to a Motion SOC chip by way of the USB 2.0 Host Controller, and the robot is driven by processing the command desired by the user.

In addition, the Motion SOC implements a USB I/F which is an interface of the WiFi module by connecting a USB 2.0 Host Device using a local bus of Static Memory Controller (SMC), which is a Microprocessor Bus Interface, for communication with the WiFi module.

Accordingly, a communication procedure as shown in FIG. 6 is needed between the T-PAD 1100 and the motion master board 200.

Specifically, the T-PAD 1100 may perform a connection attempt operation S110 and transmit corresponding connection attempt request information to the motion master board 200 through the wireless communication unit S120.

Next, the motion master board 200 may process a connection standby S130 and transmit a corresponding signal to the T-PAD 1100 S140.

In addition, the T-PAD 1100 finishes the connection operation S150 and may transmit information containing a certain command to the motion master board 200 S160.

In addition, the motion master board 200 may execute the certain command and transmit corresponding feedback information to the T-PAD 1100 S180.

The effects obtained by applying the multiple robot control system of the present invention are as described below.

Since there is no Motion Master which supports wireless communication among currently commercialized products, a motion board currently developed in an industrial strategic program is designed to mount a wireless communication function.

Although conventional cable method requires one teaching pendant for one equipment, in the present invention, since a plurality of equipments can be controlled using one wireless teaching pendant 1100 based on wireless communication, a cost saving effect may be obtained.

In addition, as the cables are removed, inconvenience of attaching or detaching a teaching pendant can be solved, and a radius of action of a user may be increased.

The access point (tower lamp) 1200 functions as a center point for establishing a communication between the T-PAD 1100 and the equipment, and this is advantageous as shown below compared to establishing a direct communication between the T-PAD 1100 and the equipment.

That is, since all data can be transmitted and received through the tower lamp 1200, data can be exchanged among the equipments.

Therefore, since equipments of the same structure may exchange data information on a teaching pendant or the like without passing through the T-PAD 1100, an efficient system can be constructed, and this is efficient to control a group of robots since a plurality of equipments can be simultaneously monitored and controlled.

In addition, as the access point (tower lamp) is separately installed in each of automated production lines, a complex process can be easily managed as shown in the following figure.

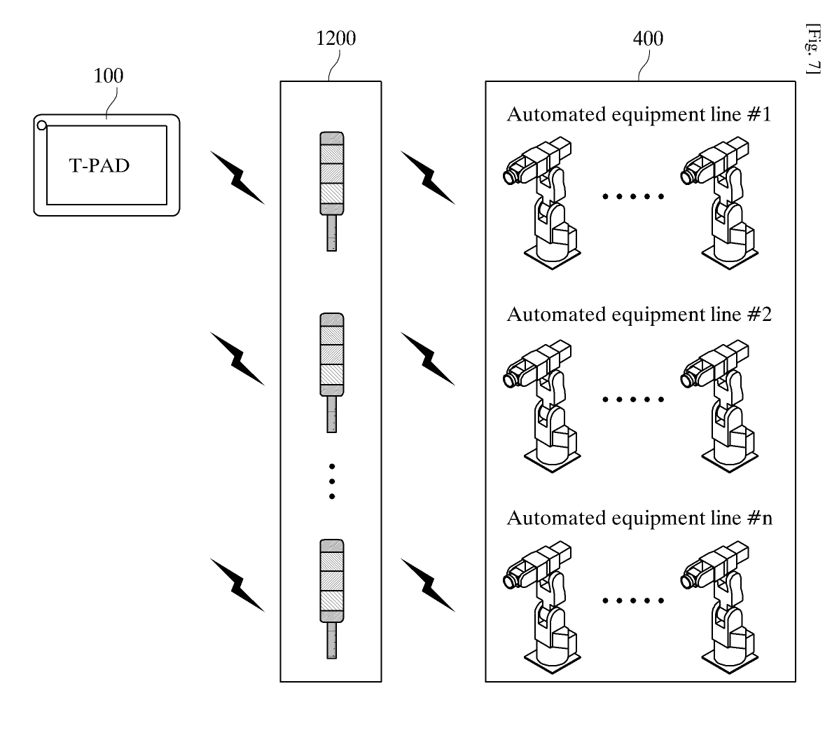

FIG. 7 is a view showing a specific example of a line expansion management configuration using an access point in relation to the present invention.

Referring to FIG. 7, a user may find a target robot further easily by searching for the access point 1200 before searching for a corresponding robot and may control the corresponding target robot.

In FIG. 7, a plurality of access points (tower lamps) 1200 for separately communicating with each of a plurality of group robots 400 is disclosed.

That is, the system can be controlled as a whole using one T-PAD 1100, and data communication with a plurality of connected group robots 400 can be performed by controlling each access point.

In addition, since the robots belong to the same group robots 400 may exchange data information on a teaching pendant or the like without passing through the T-PAD 1100, an efficient system can be constructed.

Meanwhile, since a plurality of equipments can be controlled using one T-PAD 1100 based on wireless communication, generality thereof can be increased.

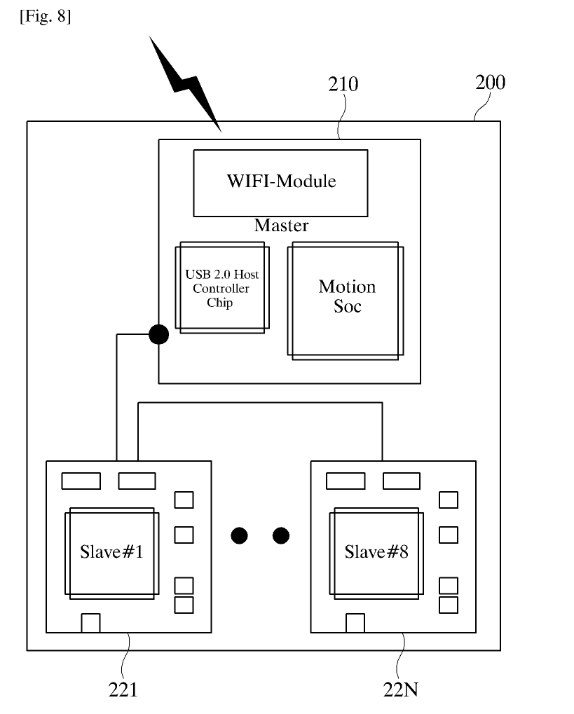

FIG. 8 is a view showing a specific example of a motion control configuration using an EtherCAT in relation to the present invention.

As is disclosed in FIG. 8, if the motion master board 200 controlling a motion drive also has generality, an effective system can be constructed.

If an existing commercialized drive such as a drive of Panasonic, Yaskawa, Elmore, Mitsubishi or the like can be controlled by mounting an EtherCAT Master 221 to 22N on the motion master board 200, advantages such as cost saving in configuring an equipment, flexibility of a system and the like can be guaranteed further more.

In addition, since the present invention uses an Android operating system, the effect of saving manufacturing cost can be maximized.

Since a conventional teaching pendant is manufactured to be fit for an equipment, it is disadvantageous in that additional cost is required when hardware (H/W) is changed.

However, when a teaching pendant pad according to the present invention is used, only software (S/W) using the Android is updated although the hardware (H/W) is changed, and thus additional cost is not required.

Accordingly, it is advantageous in that although an equipment is changed, the pad can be continuously used by updating only software (S/W) without changing a teaching pendant.

Meanwhile, the present invention can be implemented in a computer readable code in a computer readable recoding medium. The computer readable recoding medium includes all kinds of recoding devices for storing data that can be read by a computer system. Examples of the computer readable recoding medium are a ROM, a RAM, a CD-ROM, a magnetic tape, a floppy disk, an optical data storage device or the like, and, in addition, it can be implemented in the form of a carrier wave (e.g., transmission through the Internet).

In addition, since the computer readable recoding medium is distributed in computer systems connected through a network, the computer readable code may be stored and executed in a distributed method. In addition, functional programs, codes and code segments for implementing the present invention may be easily inferred by those skilled in the art.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of controlling a plurality of robots by a teaching pendant based on an access point (AP), the method comprising the steps of: transmitting first information to the AP by the teaching pendant; transmitting the first information to a plurality of related master boards by the AP; outputting a drive pulse signal using the first information by each of the plurality of master boards; and operating the plurality of robots respectively connected to the plurality of master boards according to the drive pulse signal, wherein the teaching pendant operates on an Android platform, and the teaching pendant, the AP and the plurality of motion master boards communicate using at least either a short range communication or a wireless communication.

2. The method according to claim 1, wherein the short range communication uses at least one of techniques including Wireless-Fidelity (WiFi), Bluetooth, Radio Frequency Identification (RFID), infrared Data Association (IrDA), Ultra Wideband (UWB) and ZigBee, and the wireless communication uses at least one of techniques including code division multiple access (CDMA), frequency division multiple access (FDMA), time division multiple access (TDMA), orthogonal frequency division multiple access (OFDMA), and single carrier frequency division multiple access (SC-FDMA).

3. The method according to claim 1, further comprising the steps of: transmitting a request message to the AP by the teaching pendant; transmitting the request message to the plurality of related master boards by the AP; transmitting a response message to the AP as a response to the request message by a first master board which is at least one of the plurality of master boards; and transmitting the response message to the teaching pendant by the AP, wherein the first information is transmitted only to the first master board.

4. The method according to claim 1, wherein the AP is provided in plurality, and each of the plurality of APs transmits the first information only to a plurality of master boards related to the AP itself.

5. The method according to claim 1, wherein at least some of the plurality of master boards support an EtherCAT protocol.

6. The method according to claim 1, wherein the plurality of master boards transmits and receives data to and from each other using the AP.

7. A multiple robot control system comprising: a teaching pendant for transmitting first information to an AP; the AP for transmitting the first information to a plurality of master boards related to the AP; the plurality of master boards for outputting a drive pulse signal using the first information; and a plurality of robots respectively connected to the plurality of master boards and operating according to the drive pulse signal, wherein the teaching pendant operates on an Android platform, and the teaching pendant, the AP and the plurality of motion master boards communicate using at least either a short range communication or a wireless communication.

8. The system according to claim 7, wherein the short range communication uses at least one of techniques including Wireless-Fidelity (WiFi), Bluetooth, Radio Frequency Identification (RFID), infrared Data Association (IrDA), Ultra Wideband (UWB) and ZigBee, and the wireless communication uses at least one of techniques including code division multiple access (CDMA), frequency division multiple access (FDMA), time division multiple access (TDMA), orthogonal frequency division multiple access (OFDMA), and single carrier frequency division multiple access (SC-FDMA).
